(19) United States
(12) Patent Application Publication
(10) Pub. No.: US 2025/0392815 A1
(43) Pub. Date: Dec. 25, 2025

(54) IMAGING APPARATUS

(71) Applicant: Panasonic Intellectual Property Management Co., Ltd., Osaka (JP)

(72) Inventor: Kohei FUKUGAWA, Osaka (JP)

(73) Assignee: Panasonic Intellectual Property Management Co., Ltd., Osaka (JP)

(21) Appl. No.: 19/245,265

(22) Filed: Jun. 21, 2025

(30) Foreign Application Priority Data
Jun. 24, 2024 (JP) 2024-101454

(51) Int. Cl. H04N 23/667; H04N 23/67

(52) U.S. Cl. CPC H04N 23/667; H04N 23/67

(57) ABSTRACT

An imaging apparatus includes: an image sensor that captures a subject image via an optical system to generate image data; a controller that controls continuous shooting and an autofocus operation in the image sensor; and a configurator that sets a continuous shooting mode from a first mode without displaying a live view image and a second mode with the live view image displayed and having slower shooting speed than the first mode. With the first mode being set, the controller determines, based on a state in the imaging apparatus, whether the autofocus operation is performable by a predetermined detection method in the continuous shooting by the first mode. When the autofocus operation by the predetermined detection method is performable, the controller performs the continuous shooting in the first mode. When not performable, the controller changes at least one of the continuous shooting by the first mode and the autofocus operation.

### TECHNICAL FIELD

The present disclosure relates to an imaging apparatus that performs continuous shooting and an autofocus operation.

### BACKGROUND ART

JP 2018-006827 A discloses an image pickup apparatus which shoots and displays a live view (LV) image during an interval of still image shooting in continuous shooting while displaying a black image during the still image shooting. As systems for displaying an image during continuous shooting, this image pickup apparatus is equipped with: REC view continuous shooting in which a still image for recording is reduced and displayed; and live view continuous shooting in which a live view image having a smaller number of readout pixels than the still image is displayed. In the live view continuous shooting. A live view image cannot be acquired during shooting of a still image therefore the black image is displayed as a dummy image.

In the REC view continuous shooting, the number of continuous shooting frames per unit time is easily increased because a driving mode of pixel readout need not be switched. On the other hand, in the live view continuous shooting, the number of readout pixels is smaller than that in the REC view continuous shooting, and thus display delay (latency) is small. In addition, generally, even after a live view image is switched to the black image, an action works on a human brain interpolating movement of an object when the live view image has been being displayed is said to be exerted. Therefore, when the black image is displayed instead of a live view image finally obtained continuing to be displayed, the movement of the object is felt smooth. Thus, the live view continuous shooting is said to be appropriate when a moving object is shot while being followed.

### SUMMARY

The present disclosure provides an imaging apparatus that can facilitate performing continuous shooting and an autofocus operation.

An imaging apparatus according to the present disclosure includes: an image sensor that captures a subject image via an optical system to generate image data; a controller that controls continuous shooting and an autofocus operation in the image sensor; and a configurator that sets a continuous shooting mode from a plurality of continuous shooting modes to cause the image sensor to perform continuous shooting. The plurality of continuous shooting modes includes a first continuous shooting mode and a second continuous shooting mode, the first continuous shooting mode performing the continuous shooting without displaying a live view image, the second continuous shooting mode performing the continuous shooting with the live view image displayed and at slower shooting speed than in the first continuous shooting mode. In a case where the first continuous shooting mode is set by the configurator, the controller determines, based on a state in the imaging apparatus, whether the autofocus operation is performable by a predetermined detection method in the continuous shooting by the first continuous shooting mode. When the autofocus operation by the predetermined detection method is performable, the controller performs the continuous shooting in the first continuous shooting mode. When the autofocus operation by the predetermined detection method is not performable, the controller changes at least one of the continuous shooting by the first continuous shooting mode and the autofocus operation.

The imaging apparatus according to the present disclosure can facilitate performing continuous shooting and an autofocus operation.

### BRIEF DESCRIPTION OF DRAWINGS

FIG. 1 is a diagram illustrating a configuration of a digital camera according to a first embodiment of the present disclosure;

FIG. 2 is a diagram for describing sensor pixels in an image sensor of the digital camera;

FIGS. 3A to 3C are each a diagram for describing an imaging operation in continuous shooting of the digital camera;

FIG. 4 is a flowchart for describing an operation of the digital camera;

FIG. 5 is a flowchart exemplifying a shooting standby processing in the digital camera;

FIGS. 6A and 6B are diagrams each illustrating a display example of a continuous shooting icon in the digital camera;

FIG. 7 is a flowchart exemplifying a continuous shooting processing in the digital camera;

FIGS. 8A to 8C are each a diagram for describing a display example in the continuous shooting in the digital camera;

FIG. 9 is a flowchart for describing an operation depending on an interchangeable lens in the digital camera of the first embodiment;

FIG. 10 is a flowchart for describing an operation of the digital camera according to a second embodiment;

FIGS. 11A to 11C are each a diagram illustrating a display example in the digital camera of the second embodiment; and

FIG. 12 is a diagram illustrating a display example in the digital camera of a variation of the second embodiment.

### DETAILED DESCRIPTION

In the following, embodiments will be described in detail with reference to the drawings as appropriate. However, unnecessarily detailed description may be omitted. For example, a detailed description of already well-known matters and repeated description of substantially the same configuration may be omitted. This is to prevent the following description from being unnecessarily redundant and to facilitate those skilled in the art to understand the present disclosure. Note that the inventor or inventors provide the accompanying drawings and the following description for those skilled in the art to fully understand the present disclosure, and the drawings and the description are not intended to limit the subject matters of the claims.

### First Embodiment

In a first embodiment, a digital camera that performs continuous shooting and an autofocus (AF) operation will be described as an example of the imaging apparatus according to the present disclosure.

### 1. Configuration

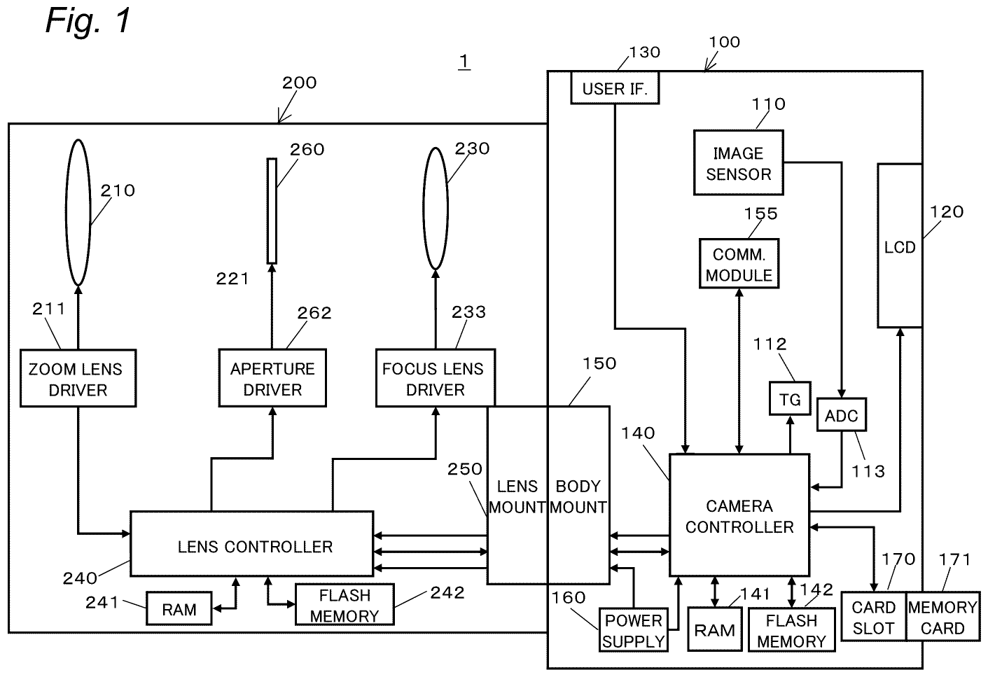

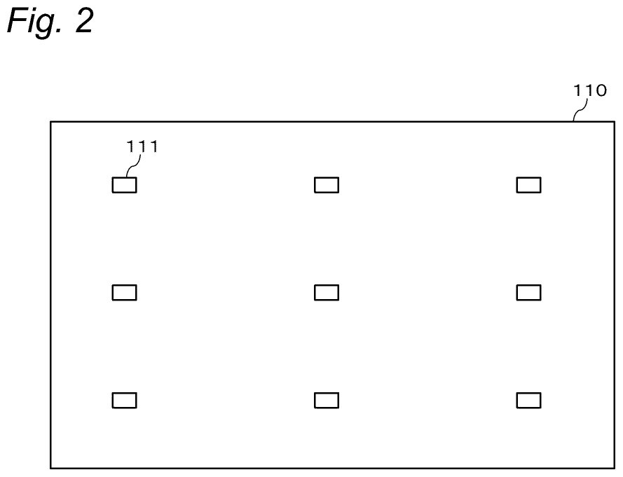

With reference to FIGS. 1 and 2, a configuration of the digital camera according to the first embodiment will be described.

FIG. 1 is a block diagram illustrating a configuration of the digital camera according to the first embodiment of the present disclosure. The digital camera 1 includes a camera body 100 and an interchangeable lens 200 detachable from the camera body 100.

### 1-1. Camera Cody

The camera body 100 includes an image sensor 110, a liquid crystal display (LCD) monitor 120, an user interface 130, a camera controller 140, a body mount 150, a communication module 155, a power supply 160, and a card slot 170.

The camera controller 140 controls an entire operation of the digital camera 1 by controlling components such as the image sensor 110 in accordance with an instruction from a release button in the user interface 130. The camera controller 140 transmits a vertical synchronization signal to a timing generator 112. In parallel with this operation, the camera controller 140 generates an exposure synchronization signal. The camera controller 140 periodically transmits the generated exposure synchronization signal to a lens controller 240 via the body mount 150 and a lens mount 250. The camera controller 140 uses an RAM 141 as a work memory in a control operation and an image processing operation.

The camera controller 140 includes a CPU and the like, and the CPU executes a program (software) to implement a predetermined function. For example, the camera controller 140 performs data communication with the lens controller 240 of the interchangeable lens 200 via the body mount 150 and the lens mount 250, and controls the AF operation of the digital camera 1 by driving a focus lens driver 233. Furthermore, the camera controller 140 adjusts exposure, as control of an automatic exposure (AE) operation, by changing a shutter speed, an ISO sensitivity, and an aperture value, for example. Furthermore, the camera controller 140 controls continuous shooting in which still images are continuously captured in the image sensor 110.

The image sensor 110 is an element that captures a subject image incident via the interchangeable lens 200 to generate image capturing data. The image capturing data constitutes image data representing a captured image by the image sensor 110. The image sensor 110 is a CCD, a CMOS image sensor, or an NMOS image sensor, for example. The generated image capturing data is digitized by an AD converter (ADC) 113. The digitized image data is subjected to predetermined image processing by the camera controller 140. Examples of the predetermined image processing include interpolation processing on light-shielded pixels corresponding to sensor pixels 111 in the image sensor 110, which are described later, gamma correction processing, white balance correction processing, defect correction processing, YC conversion processing, electronic zoom processing, and/or JPEG compression processing.

Furthermore, on the basis of the image data from the image sensor 110, various types of image recognition processing are performed by the camera controller 140, for example. For example, in an image represented by the image data, a subject area corresponding to a subject such as a person is recognized by image recognition processing. The subject area may be recognized as a rectangular area surrounding the subject in the image. The recognized subject area is managed based on a position in the image, as an AF area to be focused on as an AF operation target, for example. Such an AF area may be automatically determined based on a recognition result of the subject area by the camera controller 140 using a position on the image, or may be designated by a user operation on the user interface 130, for example.

The camera controller 140 controls a generation timing of the image data and an electronic shutter operation by the image sensor 110. For example, the image sensor 110 operates at a timing that is controlled by the camera controller 140 via the timing generator (TG) 112. The image sensor performs an imaging operation of a still image or a moving image for recording or a through image. The through image is mainly a moving image and is displayed on the LCD monitor 120 for a user to determine a composition for capturing a still image. The image sensor 110 is an example of an image sensor of the present embodiment.

The image sensor 110 of the present embodiment includes sensor pixels 111 for an image plane phase difference method. FIG. 2 is a diagram for describing the sensor pixels 111 in the image sensor 110.

The sensor pixels 111 for the image plane phase difference method are arranged instead of pixels for image capturing, on an image plane of the image sensor 110 as illustrated in FIG. 2, for example. That is, the image sensor 110 includes light-shielded pixels in image capturing, the number of light-shielded pixels being equal to the number of the sensor pixels 111. On the image plane of the image sensor 110, the respective sensor pixels 111 are disposed at positions each being arranged as a distance measurement target in a distance measurement function of the image plane phase difference method. The respective sensor pixels 111 constitute distance measurement points of the image plane phase difference method. For example, the sensor pixels 111 each include a photoelectric converter and the like that is sectioned to form two types of optical images obtained by pupil-division in an optical system of the interchangeable lens 200.

With reference again to FIG. 1, the LCD monitor 120 displays various types of information including an image such as a through image and a menu screen, for example. Instead of the LCD monitor, another type of a display device such as an organic EL display device may be used, for example. The LCD monitor 120 displays a through image captured by the image sensor 110 as a live view image in real time, for example.

The user interface 130 is a generic term for hardware keys that are provided on an exterior of the camera body 100 to receive a user operation. The user interface 130 includes various operation members such as a release button for instructing a start of image shooting, a mode dial for setting an image shooting mode, and a power switch.

The user interface 130 may include a touch panel stacked on the LCD monitor 120, and may receive a user operation on a menu screen or the like displayed on the LCD monitor 120. When receiving a user operation, the user interface 130 transmits to the camera controller 140 an operation signal corresponding to the user operation.

The RAM 141 is a recording medium implemented by a dynamic random access memory (DRAM) or the like, and functions as a work memory for the camera controller 140, for example. The camera controller 140 may include various internal memories, and may incorporate an ROM, for example. The ROM stores various programs to be executed by the camera controller 140. Furthermore, the camera controller 140 may incorporate an RAM functioning as a working area for the CPU.

A memory card 171 can be mounted on the card slot 170, and the card slot 170 accesses the memory card 171 on the basis of control from the camera controller 140. The digital camera 1 can store image data in the memory card 171 and read image data from the memory card 171.

The communication module 155 is a communication module (circuit) that performs communication confirming with communication standards such as IEEE 802.11, Wi-Fi (registered trademark), or the like. The digital camera 1 can communicate with other devices via the communication module 155 on the basis of a control signal that is output from the camera controller 140, for example. The digital camera 1 may directly communicate with other devices via the communication module 155, or may communicate via an access point. The communication module 155 may be connectable to a communication network such as the Internet. The communication module 155 may function as an interface for wired connection to an external device in conformity with a predetermined standard, and may include a connection circuit confirming to USB and/or HDMI (registered trademark) standard, for example.

The power supply 160 is a circuit that supplies power to each element in the digital camera 1.

The body mount 150 can be mechanically and electrically connected to the lens mount 250 of the interchangeable lens 200. The body mount 150 can transmit and receive data to and from the interchangeable lens 200 via the lens mount 250. The body mount 150 transmits the exposure synchronization signal received from camera controller 140 to the lens controller 240 via the lens mount 250. In addition, other control signals received from the camera controller 140 are transmitted to the lens controller 240 via the lens mount 250. The body mount 150 transmits a signal received from the lens controller 240 via the lens mount 250 to the camera controller 140. Furthermore, the body mount 150 supplies power from the power supply 160 to the entire interchangeable lens 200 via the lens mount 250.

### 1-2. Interchangeable Lens

The interchangeable lens 200 includes the optical system, the lens controller 240, and the lens mount 250. The optical system includes a zoom lens 210, a focus lens 230, and an aperture diaphragm 260.

The zoom lens 210 is a lens for changing a magnification ratio of a subject image formed by the optical system. The zoom lens 210 is configured with one or more lenses. The zoom lens 210 is driven by a zoom lens driver 211. The zoom lens driver 211 includes a zoom ring operable by a user. The zoom lens driver 211 may include a zoom lever, an actuator, or a motor. The zoom lens driver 211 moves the zoom lens 210 along an optical axis direction of the optical system in accordance with the user operation.

The focus lens 230 is a lens for changing a focusing state of the subject image formed on the image sensor 110 by the optical system. The focus lens 230 is configured with one or more lenses. The focus lens 230 is driven by a focus lens driver 233.

The focus lens driver 233 includes an actuator or a motor, and moves the focus lens 230 along the optical axis of the optical system on the basis of control of the lens controller 240. The focus lens driver 233 can be implemented by a DC motor, a stepping motor, a servo motor, an ultrasonic motor, or the like.

The lens controller 240 integrally controls an operation of the interchangeable lens 200. The lens controller 240 includes a CPU or the like, and the CPU executes a program (software) to implement a predetermined function. The lens controller 240 controls each component of the interchangeable lens 200 on the basis of a control signal received from the camera controller 140 via the body mount 150 and the lens mount 250, for example.

The RAM 241 is a recording medium implemented by a DRAM or the like, and functions as a work memory for the lens controller 240, for example. The lens controller 240 may include various internal memories similarly to the camera controller 140. A flash memory 242 is a non-volatile recording medium. For example, the flash memory 242 stores lens data unique to the interchangeable lens 200. The lens data includes optical characteristic information indicating optical characteristics of the interchangeable lens 200, an identifier of the interchangeable lens 200, and the like, for example.

The aperture diaphragm 260 adjusts an amount of light incident on the image sensor 110. The aperture diaphragm 260 is driven by a diaphragm driver 262, whereby a size of the opening is controlled. The diaphragm driver 262 includes a motor or an actuator.

The camera controller 140 and the lens controller 240 may each be configured with a hard-wired electronic circuit, or may each be configured with a microcomputer using a program, or the like. For example, the camera controller 140 and the lens controller 240 can be each implemented by various processors such as a CPU, an MPU, a GPU, a DSU, an FPGA, and an ASIC. The controllers 140 and 240 may be respectively configured as one semiconductor chip together with the RAMs 141 and 241, or may each be configured with separate semiconductor chips.

1-3. AF control method

In the digital camera 1 of the present embodiment, each as a method in which the camera controller 140 controls the AF operation, the following methods are available: a phase difference detection method based on distance measurement by the image plane phase difference method, and a contrast detection method. Hereinafter, the AF by the image plane phase difference method is referred to as “PDAF”, and the AF by the contrast detection method is referred to as “contrast AF”.

In the PDAF, the camera controller 140 performs distance measurement by the image plane phase difference method based on sensor signals that are input from the sensor pixels 111 of the image sensor 110. For example, to perform the distance measurement by the image plane phase difference method, for each distance measurement point defined by the sensor pixels 111, a defocus amount or the like is calculated from the sensor signals in accordance with a difference between the two types of optical images obtained by pupil division. A known technique can be appropriately applied to the AF operation based on distance measurement by the image plane phase difference method (see e.g., JP 2014-063142 A).

In the contrast AF, the camera controller 140 causes the lens controller 240 to control the focus lens driver 233 on the basis of signals that are input from pixels for image capturing included in the image sensor 110. For example, the focus lens 230 is driven to maximize contrast in an image represented by image data generated on the basis of the signals. The contrast AF is performed by maximizing the contrast while changing the focusing state of a subject image and is therefore performed the basis of a live view image or the like captured separately from a still image for recording.

### 2. Operation

A description will be given below to an operation of the digital camera 1 configured as described above.

### 2-1. Outline of Continuous Shooting Operation

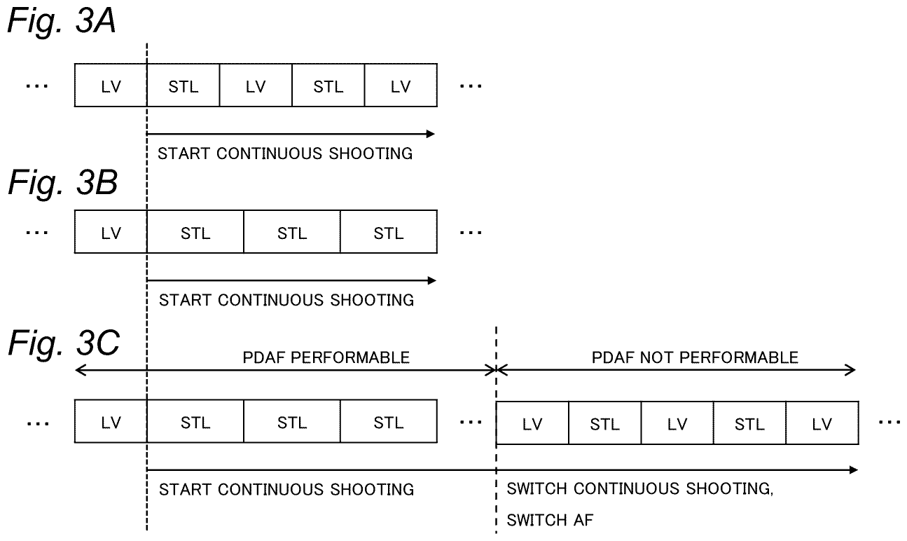

In the digital camera 1 according to the present embodiment, a continuous shooting mode can be set as an operation mode to perform continuous shooting. An imaging operation in the continuous shooting of the digital camera 1 will be described with reference to FIGS. 3A to 3C. Hereinafter, an example will be described in which an operation mode is set in the digital camera 1, the operation mode being set to perform the AF operation to track motion of the subject in the imaging operation of still images, through images, and the like in continuous shooting, for example.

The digital camera 1 according to the present embodiment has a plurality of continuous shooting modes each associated with a continuous shooting speed or the like. The digital camera 1 receives a user operation selecting continuous shooting mode via the user interface 130, to set the selected continuous shooting mode, for example. The plurality of continuous shooting modes includes an H+ continuous shooting mode in which continuous shooting is performed at a relatively high speed (e.g., 10 frames/second) and an H continuous shooting mode in which continuous shooting is performed at a lower speed (e.g., 7 frames/second) than in the H+ continuous shooting mode.

FIG. 3A exemplifies an imaging operation in the H continuous shooting mode. In response to a half-press operation of the release button in the user interface 130 or the like, the digital camera 1 starts a shooting standby processing before image shooting, and performs the AF operation to track a subject in parallel with repeating shooting of a live view (LV) image. Then, when the digital camera 1 starts continuous shooting in response to a full-press operation of the release button or the like, in the H continuous shooting mode, the digital camera 1 alternately repeats capturing a still image (STL) for recording and capturing a live view image to be displayed on the LCD monitor 120.

FIG. 3B exemplifies an imaging operation in the H+ continuous shooting mode. For example, when the digital camera 1 starts continuous shooting after the shooting standby process similarly to the H continuous shooting mode, in the H+ continuous shooting mode, the digital camera 1 repeats capturing only the still image without capturing the live view image. For example, by omitting capturing of live view images, it is possible to perform continuous shooting at a higher speed in the H+ continuous shooting mode than in the H continuous shooting mode. In the examples of FIGS. 3A and 3B, in the same period elapsed from the start of continuous shooting, two still images are captured in the H continuous shooting mode, whereas three still images are captured in the H+ continuous shooting mode.

In the H+ continuous shooting mode, since the digital camera 1 of the present embodiment performs relatively high-speed continuous shooting without capturing the live view image, the digital camera 1 performs the AF operation by the PDAF without displaying the live view image in the continuous shooting. When the H+ continuous shooting mode is set in the digital camera 1, the PDAF may not be performable depending on a state in the digital camera 1 such as a setting for image shooting, for example.

Therefore, in a case where the PDAF is not performable in the H+ continuous shooting mode as illustrated in FIG. 3C, the digital camera 1 of the present embodiment changes the imaging operation in the continuous shooting to an imaging operation similar to that in the H continuous shooting mode as illustrated in FIG. 3A, for example. Then, the digital camera 1 switches the AF operation from the PDAF to the contrast AF or the like. As described above, the digital camera 1 according to the present embodiment can continue the AF operation even when the PDAF cannot be performed in the continuous shooting by the H+ continuous shooting mode.

2-2. Overall operation

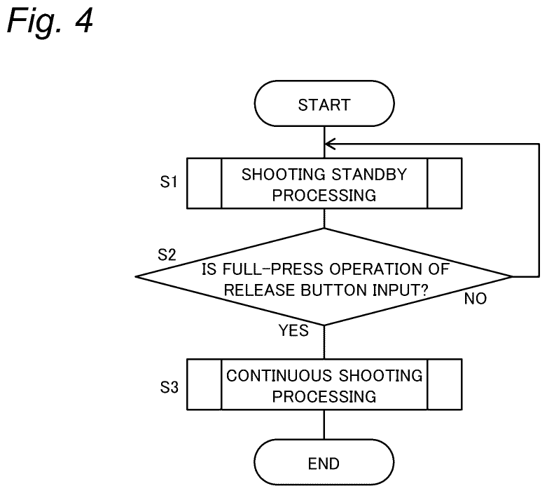

With reference to FIGS. 4 to 7, an overall operation when the H+ continuous shooting mode as described above is set in the digital camera 1 of the present embodiment will be described.

FIG. 4 is a flowchart for describing the operation of the digital camera 1. The process illustrated in the flowchart of FIG. 4 is started when the half-press operation of the release button is input on the user interface 130 of the digital camera 1, for example. Each process of this flowchart is performed by the camera controller 140, for example.

Waiting for image shooting before continuous shooting, such as receiving the half-press operation of the release button, the camera controller 140 displays various indications on the LCD monitor 120 depending on whether the PDAF is performable, continuously performing the AF operation by the PDAF or the contrast AF, for example (step S1). In parallel with such shooting standby processing (step S1), the camera controller 140 causes the image sensor 110 to capture a live view image, and causes the LCD monitor 120 to display the captured live view image. These displays enable the user to easily perform continuous shooting, for example. Details of the shooting standby process (step S1) will be described later.

Next, the camera controller 140 determines whether the full-press operation of the release button is input on the user interface 130 (step S2). When the full-press operation is not input (step S2: NO), the camera controller 140 repeats the shooting standby processing (step S1).

When the full-press operation is input (step S2: YES), the camera controller 140 causes the image sensor 110 to continuously capture still images so that continuous shooting is continued during the full-press operation, for example (step S3). In the present embodiment, in a case where the PDAF is not performable as illustrated in FIG. 3C, the camera controller 140 changes the imaging operation in the continuous shooting to the imaging operation similar to that in the H continuous shooting mode, and causes the image sensor 110 to capture live view images in addition to still images, for example. In this case, the camera controller 140 can continue the AF operation by the contrast AF or the like on the basis of the live view images, for example. Details of such continuous shooting processing (step S3) will be described later.

As the above operation, in the digital camera 1 in which the H+ continuous shooting mode is set, the shooting standby processing (step S1) is repeated until the full-press operation of the release button is input (step S2: NO), and after the full-press operation is input (step S2: YES), the continuous shooting processing (step S3) is performed.

### 2-3. Shooting Standby Processing

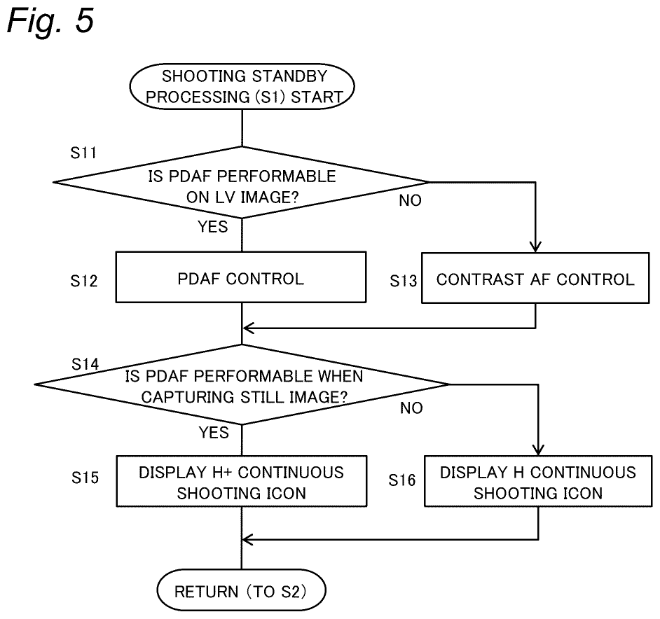

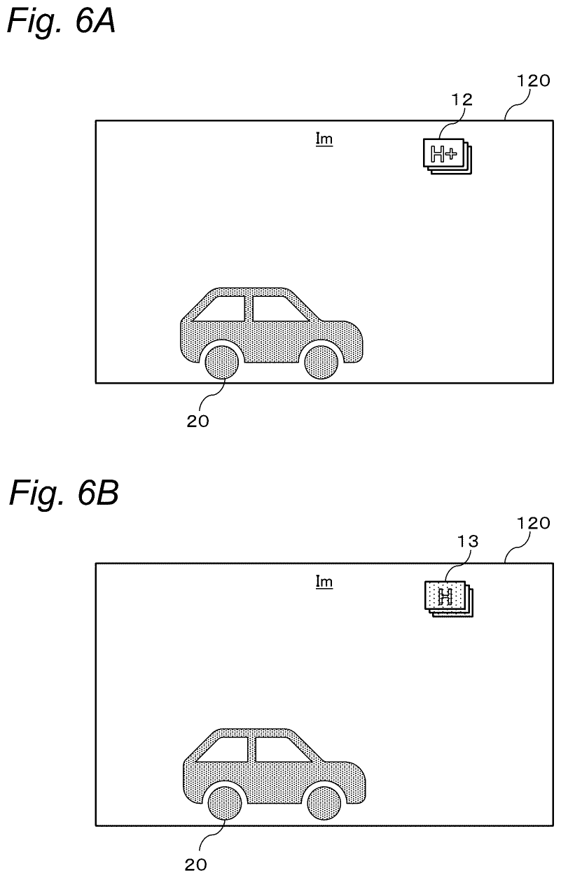

With reference to FIGS. 5, 6A, and 6B, details of the shooting standby processing in step S1 in FIG. 4 will be described.

FIG. 5 is a flowchart exemplifying the shooting standby processing (step S1) in the digital camera 1. The processing of this flowchart is performed in a state where live view images are being captured by the image sensor 110 with the half-press operation of the release button in the user interface 130 being performed.

The camera controller 140 determines whether the PDAF is performable on the captured live view image (step S11). For example, the camera controller 140 performs the determination in step S11 on the basis of a recognition result of the AF area on the live view image. When the PDAF is performable (step S11: YES), the camera controller 140 controls the AF operation by the PDAF (step S12).

On the other hand, for example, in a case where a recognized position of the AF area corresponds to a position outside of an area where the PDAF is performable in the image sensor 110, the camera controller 140 determines that the PDAF is not performable (step S11: NO). Such a PDAF performable area on the image sensor 110 is set in advance in accordance with optical characteristics of the interchangeable lens 200, and is stored in a flash memory 142 or the like, for example. In step S11, the camera controller 140 may acquire the lens data from the interchangeable lens 200 to determine the PDAF performable area on the basis of the optical characteristic information in the lens data and/or the identifier of the interchangeable lens 200.

In addition to the above case, also in a case where it is impossible to obtain a detection result for calculating a defocus amount or the like by the PDAF on the basis of the sensor signals from the sensor pixels 111, the camera controller 140 determines that the PDAF is not performable (step S11: NO). For example, it is conceivable that the detection result by the PDAF cannot be obtained due to a factor such that contrast in the AF area is excessively low.

When the PDAF is not performable on the live view image (step S11: NO), the camera controller 140 controls the AF operation by the contrast AF, for example (step S13).

For example, in addition to the AF control with the half-press operation of the release button being performed as described above (steps S12 and S13), the camera controller 140 determines whether the PDAF is performable on the still image to be captured in the continuous shooting processing (step S3), to which the processing proceeds after the full-press operation is performed (step S2: YES) (step S14). For example, the camera controller 140 performs the determination in step S14 on the basis of set values of the ISO sensitivity and the aperture value in capturing the still image. With the half-press operation of the release button being performed, the set values are determined by a user operation or the AE operation on the live view image, depending on a set image shooting mode from various image shooting modes of the digital camera 1, for example.

Based on the setting for image shooting as described above, the camera controller 140 determines that the PDAF is not performable (step S14: NO) in at least one of the following cases: a case where the ISO sensitivity is a predetermined value (e.g., “6400”) or higher; and a case where the aperture value is larger than a predetermined value (e.g., “F8”). The predetermined values of the sensitivity and the aperture value are set depending on characteristics of the image sensor 110 and the optical system from a viewpoint of accurately performing the PDAF, and are stored in the flash memory 142 or the like, for example.

In step S14, similarly to step S11, the camera controller 140 further determines whether the PDAF is performable based on the AF area in the latest live view image. The camera controller 140 may manage the determination result of step S14 in the RAM 141 or the like by a predetermined flag, for example.

When the camera controller 140 determines that the PDAF is performable at the time of capturing a still image in the continuous shooting processing (step S3) (step S14: YES), the camera controller 140 causes the LCD monitor 120 to display an H+ continuous shooting icon on a live view image, for example (step S15). The H+ continuous shooting icon indicates that the continuous shooting is performed by the imaging operation in the H+ continuous shooting mode as illustrated in FIG. 3B.

FIG. 6A illustrates a display example of the H+ continuous shooting icon 12 in the digital camera 1. For example, as the example illustrated in FIG. 6A, the LCD monitor 120 displays the H+ continuous shooting icon 12 on a captured image Im such as a live view image. The captured image Im of the present example includes a subject 20 such as an AF target.

On the other hand, when the camera controller 140 determines that the PDAF is not performable at the time of capturing a still image (step S14: NO), the camera controller 140 causes the LCD monitor 120 to display an H continuous shooting icon instead of the H+ continuous shooting icon displayed in step S15 (step S16). The H continuous shooting icon indicates that continuous shooting is performed by the imaging operation in the H continuous shooting mode.

FIG. 6B illustrates a display example of the H continuous shooting icon 13. As illustrated in, FIG. 6B, the LCD monitor 120 displays the H continuous shooting icon 13 on the captured image Im such as a live view image in a display mode different from that of the H+ continuous shooting icon 12 in FIG. 6A, for example. In the examples of FIGS. 6A and 6B, the continuous shooting icons 12 and 13 are displayed in different shapes and colors, but one of the shapes and the colors may be different, or the continuous shooting icons 12 and 13 may be displayed to be different in other appearances.

After the H+ continuous shooting icon 12 or the H continuous shooting icon 13 is displayed (step S15 or S16), the camera controller 140 ends the processing of this flowchart and proceeds to step S2 in FIG. 4. When the full-press operation of the release button is not input on the user interface 130 (step S2: NO), the camera controller 140 repeats the processes in step S11 and the following steps.

According to the above shooting standby processing (step S1), the AF operation is controlled by the PDAF or the contrast AF (step S12 or S13) depending on whether the PDAF is performable on a live view image (step S11). Therefore, a subject such as the AF target can be tracked. Then, depending on whether the PDAF is performable at the time of capturing a still image in the subsequent continuous shooting processing (S3) (step S14), the H+ continuous shooting icon 12 or the H continuous shooting icon is displayed (step S15 or S16). Therefore, for example, it is possible to notify the user of a behavior of the imaging operation in the continuous shooting before the continuous shooting starts.

In the shooting standby processing (step S1) described above, the camera controller 140 controls the AF operation by switching between the PDAF and the contrast AF depending on whether the PDAF is performable (steps S11 to S13). The shooting standby processing (step S1) does not need to be performed as in the above example. For example, only the contrast AF may be performed, and the determination in step S11 may not be performed. When the PDAF is not performable (step S11: NO), the AF operation may be performed by another control method instead of the contrast AF in step S13.

Furthermore, the camera controller 140 may acquire data from the interchangeable lens 200, the data indicating a state that changes due to various types of control and the like in the digital camera 1, and may perform determinations in steps S11 and S14 on the basis of the indicated state, for example. In step S14 described above, the camera controller 140 may determine whether the PDAF is performable, not only based on both of the set values of the ISO sensitivity and the aperture value but also based on one of the ISO sensitivity and the aperture value.

### 2-4. Continuous Shooting Processing

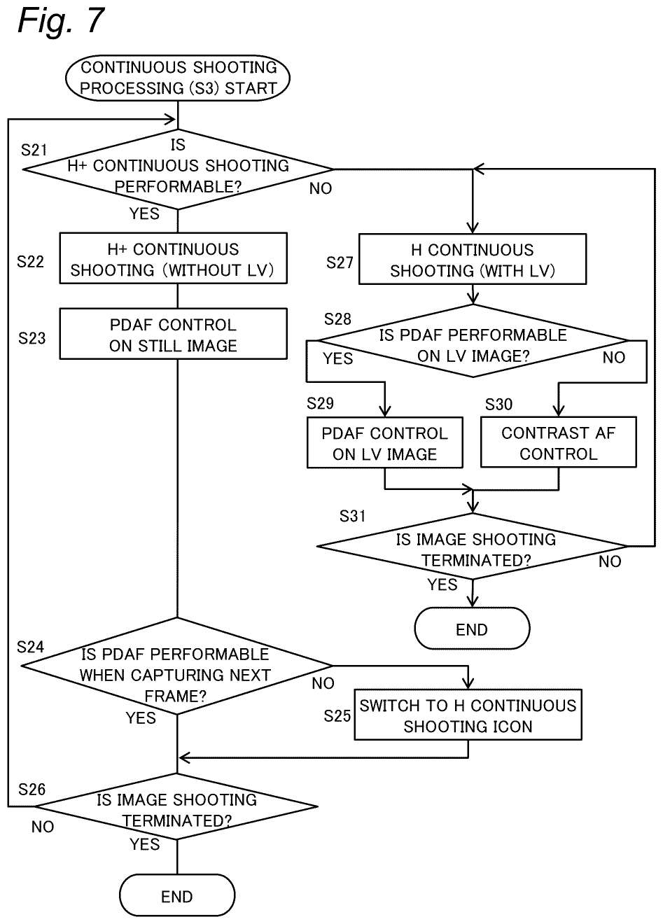

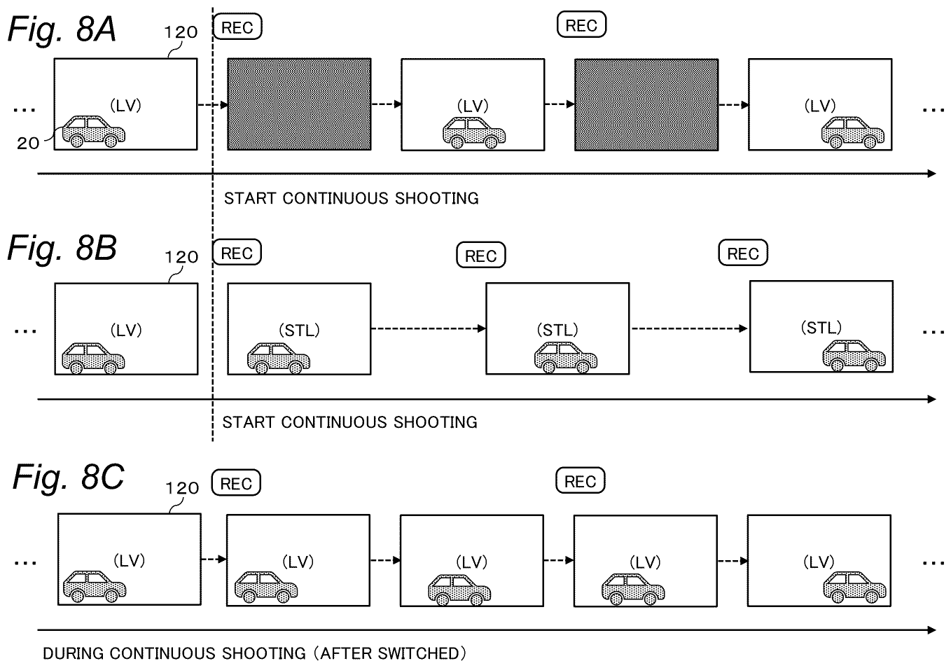

With reference to FIGS. 7 to 8C, details of the continuous shooting processing in step S3 in FIG. 4 will be described.

FIG. 7 is a flowchart exemplifying the continuous shooting processing (step S3) in the digital camera 1. The process of this flowchart is started after the full-press operation of the release button (step S2: YES) is performed and in a state where a determination result of step S14 in the shooting standby processing (step S1) before the full-press operation is held in the RAM 141, for example. The determination result can be held by a flag or the like indicating whether the PDAF is performable.

For example, referring to the flag held according to whether the PDAF is performable, the camera controller 140 determines whether the continuous shooting by the H+ continuous shooting mode (also referred to as “H+ continuous shooting”) is performable (step S21).

When the H+ continuous shooting is performable (step S21: YES), the camera controller 140 performs the H+ continuous shooting to cause the image sensor 110 to capture a still image as illustrated in FIG. 3B, for example (step S22). On the basis of the still image, the camera controller 140 may determine exposure by the AE operation for a frame to be captured next in the continuous shooting, for example. Furthermore, the camera controller 140 causes the LCD monitor 120 to display the captured still image, for example. Details of such a display operation in the continuous shooting will be described later.

Furthermore, the camera controller 140 performs various calculations of the PDAF based on the captured still image to control the AF operation by the PDAF (step S23). For example, the camera controller 140 performs the image recognition processing to recognize the AF area in the captured still image.

On the basis of the still image captured in step S22, the camera controller 140 determines whether the PDAF is performable on an image of the frame to be captured next in the continuous shooting, for example (step S24). For example, the camera controller 140 determines whether the PDAF is performable by comparing the set values of the ISO sensitivity and the aperture value with predetermined values similar to those in step S14 of the shooting standby processing (step S1). The set values may be determined in the exposure determined by the AE operation on the basis of the image captured in step S22. Furthermore, for example, based on the recognition result of the AF area on the still image in step S23 and on the detection result by various calculations of the PDAF, the camera controller 140 determines whether to perform the PDAF, similarly to step S11 of the shooting standby processing (step S1).

For example, when the camera controller 140 determines that the PDAF is not performable for imaging of the next frame (step S24: NO), the camera controller 140 switches from the H+ continuous shooting icon displayed since the shooting standby processing (step S1) to the H continuous shooting icon on the LCD monitor 120 (step S25). The camera controller 140 causes the LCD monitor 12 to display the H continuous shooting icon on the still image captured in step S22, for example. For example, in step S25, the camera controller 140 changes the flag or the like held in the RAM 141 depending on whether the PDAF is performable so that the flag indicates that the H+continuous shooting is not performable.

After switching to the H continuous shooting icon (step S25), the camera controller 140 determines whether an instruction to end the continuous shooting is issued (step S26). Also in a case where the camera controller 140 determines that the PDAF is performable at the time of capturing the next frame (step S24: YES), the determination in step S26 is performed. For example, when the full-press operation of the release button is released on the user interface 130, the camera controller 140 determines that the instruction to end the continuous shooting is issued (step S26: YES), and terminates the processing of this flowchart.

When the instruction to end the shooting is not issued (step S26: NO), the camera controller 140 repeats the process in step S21 and the following steps.

When the camera controller 140 determines that the H+ continuous shooting is not performable on the basis of the held flag or the like (step S21: NO), the camera controller 140 performs, instead of the H+ continuous shooting (step S22), continuous shooting by an imaging operation similar to that in the H continuous shooting mode (step S27). In such H continuous shooting, the camera controller 140 causes the image sensor 110 to capture a live view image and a still image as illustrated in FIG. 3C, as an operation after the switching of continuous shooting, for example (step S27). The camera controller 140 causes the LCD monitor 120 to display the captured live view image, for example.

The camera controller 140 determines whether the PDAF is performable on the captured live view image, similarly to step S24, for example (step S28). For example, in an image shooting mode such as an aperture priority mode in which an aperture value is designated by a user operation, even when the aperture value for capturing a still image is larger than the predetermined value at which the PDAF is performable, the aperture value can be made smaller than the predetermined value in capturing a live view image. In such a case, even when it is determined that the PDAF is not performable on the still image (step S24: NO), the PDAF can be performable on the live view image (step S28: YES).

When the PDAF is performable on the live view image (step S28: YES), the camera controller 140 controls the AF operation by the PDAF on the live view image (step S29).

On the other hand, when the PDAF is also not performable on the live view image (step S28: NO), the camera controller 140 controls the AF operation by the contrast AF on the basis of the live view image, for example (step S30).

After performing the AF control (steps S29 and S30), the camera controller 140 determines whether the instruction to end the shooting is issued, similarly to step S26 (step S31). When the instruction to end the shooting is issued (step S31: YES), the process of this flowchart is terminated.

In the present embodiment, when the instruction to end the shooting is not issued (step S31: NO), the camera controller 140 repeats the process in step S27 of the H continuous shooting and the following steps. As described above, after the continuous shooting being performed in the H+ continuous shooting mode is switched to the H continuous shooting, the H continuous shooting is performed until the shooting ends regardless of whether the PDAF is performable.

According to the above continuous shooting processing (step S3), depending on whether the H+ continuous shooting is performable according to whether the PDAF on a still image is performable (steps S21 and S24), either the H+ continuous shooting in which a live view image is not captured or the H continuous shooting in which a live view image is captured is performed (steps S22 and S27). Even when the PDAF is not performable on the still image (step S14: NO, step S21: NO, step S24: NO), the contrast AF or the like based on the captured live view image can be performed in the H continuous shooting (step S29 and S30), so that the AF operation can be continued.

Furthermore, in the H+ continuous shooting, when it is determined that the PDAF is not performable for the imaging in the next frame (step S24: NO), the H continuous shooting icon is displayed instead of the H+ continuous shooting icon (step S25). Therefore, it is possible to notify the user of the switching to the H continuous shooting.

Furthermore, in the present embodiment, once the continuous shooting being performed is changed to the H continuous shooting, the H continuous shooting after the change is continued regardless of whether the PDAF is performable (steps S27 to S31). Therefore, for example, even when the performability of the PDAF changes in continuous shooting due to a change in the AF area or a change in the setting for image shooting caused by automatic or manual exposure control, it is possible to suppress frequent switching between the H continuous shooting and the H+ continuous shooting.

In the above example, when the PDAF is performable on the live view image (step S28: YES), the PDAF on the live view image is performed (step S29). For example, the camera controller 140 does not need to perform the determination in step S28, and may perform the contrast AF based on the live view image in the H continuous shooting.

### 2-4-1. Display Operation in Continuous Shooting

With reference to FIGS. 8A to 8C, a description will be given on an operation displaying captured images when performing continuous shooting in the digital camera 1 of the present embodiment.

FIGS. 8A to 8C are diagrams for describing a display example in continuous shooting in the digital camera 1. FIG. 8A illustrates a display example in the H continuous shooting mode. FIG. 8B illustrates a display example of images captured by the H+ continuous shooting (step S22 in FIG. 7) in the H+ continuous shooting mode. FIG. 8C illustrates a display example of images captured by the H continuous shooting (step S27 in FIG. 7) in the H+ continuous shooting mode.

In the digital camera 1, when the H continuous shooting mode is set, as illustrated in FIG. 8A, the LCD monitor 120 displays live view images when performing the shooting standby processing (step S1), and displays black images in addition to the live view images after the continuous shooting processing is started, for example (step S3). The black image is stored in advance in the flash memory 142, for example. The black image is displayed for a blank period such as a period in which a live view image cannot be obtained due to capturing of a still image, the capturing being indicated as “REC” in FIG. 8A, for example. As a result, motion of the subject 20 can be perceived to be smooth on the live view images sequentially captured and displayed between the still images.

When the H+ continuous shooting mode is set, after the continuous shooting processing (step S3) is started in the H+ continuous shooting, in which a live view image is not captured, as illustrated in FIG. 8B, the LCD monitor 120 displays the latest captured still image until the next still image is captured, for example.

Furthermore, in the continuous shooting processing (step S3) in the H+ continuous shooting mode, when the H+ continuous shooting is switched to the H continuous shooting, the live view images are displayed as illustrated in FIG. 8C, for example. In this case, in the digital camera 1 of the present embodiment, instead of the black image in the H continuous shooting mode illustrated in FIG. 8A, the latest captured live view image is continuously displayed for the period in which a still image is being captured, for example. As a result, for example, before and after the switching from the H+ continuous shooting to the H continuous shooting, a change in the display can be suppressed, and the user can easily see the images captured during the continuous shooting.

### 2-5. Operation Depending on Interchangeable Lens

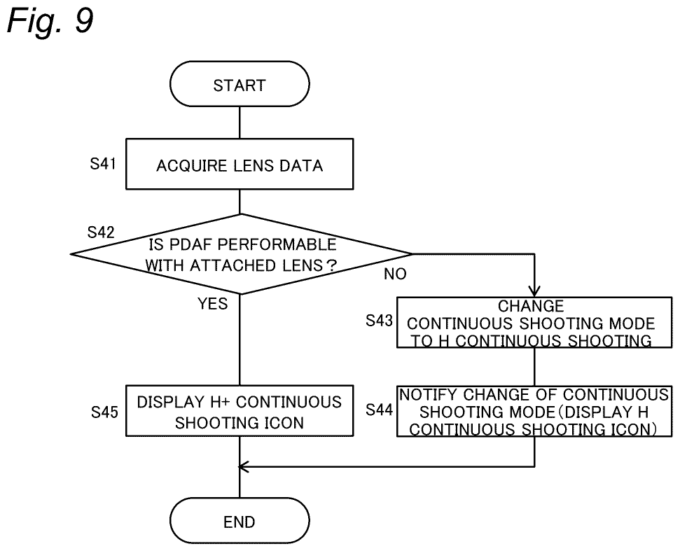

In addition to the above operation (steps SI to S3, FIGS. 3A to 8C) after the half-press operation of the release button, the digital camera 1 according to the present embodiment performs, regarding continuous shooting, an operation depending on the interchangeable lens 200 mounted on the camera body 100. Such an operation depending on the interchangeable lens 200 will be described with reference to FIG. 9.

FIG. 9 is a flowchart for describing the operation depending on the interchangeable lens 200 in the digital camera 1 of the present embodiment. The processing of this flowchart is started when the digital camera 1 is activated in a state where the H+ continuous shooting mode is set or when the interchangeable lens 200 is mounted in such a state, for example. Alternatively, this processing is started when a user operation selecting the H+ continuous shooting mode is input on the user interface 130 by using a setting menu or the like. Each process of this flowchart is performed by the camera controller 140, for example.

The camera controller 140 acquires the lens data from the interchangeable lens 200 mounted on the camera body 100 via the body mount 150 and the lens mount 250, for example (step S41).

Based on the lens data, the camera controller 140 determines whether the PDAF is performable in the image capturing through the mounted interchangeable lens 200 (step S42). For example, when the data referred to in the PDAF control is not included in the lens data and/or when a full-aperture F-number of the aperture diaphragm 260 is larger than a predetermined value, it is determined that the PDAF is not performable (step S42: NO).

When the PDAF is not performable with the mounted interchangeable lens 200 (step S42: NO), the camera controller 140 changes the H+ continuous shooting mode set in the digital camera 1 to the H continuous shooting mode (step S43).

The camera controller 140 causes the LCD monitor 120 to display the H continuous shooting icon 13 (see FIG. 6B) to notify the user of the change of the continuous shooting mode, for example (step S44). For example, in addition to the H continuous shooting icon 13, a message and the like indicating the change of the continuous shooting mode may be displayed.

On the other hand, when the PDAF is performable (step S42: YES), the camera controller 140 causes the LCD monitor 120 to display the H+ continuous shooting icon 12 (see FIG. 6A) (step S45).

The camera controller 140 ends the processing of this flowchart after displaying the H continuous shooting icon 13 or the H+ continuous shooting icon 12, for example (step S44 or S45).

According to the above processing, in the digital camera 1 in which the H+ continuous shooting mode is set, it is determined whether the PDAF is performable, on the basis of the lens data acquired from the interchangeable lens 200 mounted on the camera body 100 (steps S41 and S42). When the PDAF is not performable with the interchangeable lens 200 (step S42: NO), the continuous shooting mode of the digital camera 1 is changed to the H continuous shooting mode (step S43). As a result, for example, in the continuous shooting by the H continuous shooting mode, the AF operation can be performed in which the subject is being tracked by the contrast AF or the like on the basis of the captured live view image. Furthermore, by displaying the continuous shooting icon 12 or 13, it is possible to notify the user of the continuous shooting mode (step S44 or S45).

In the above example, the change of the continuous shooting mode is notified (step S44), but it is not necessary to notify of the change depending on the interchangeable lens 200, and step S44 may not be performed. Furthermore, regardless of whether the PDAF is performable with the attached interchangeable lens 200, the H+ continuous shooting icon may be displayed when the H+ continuous shooting mode is set.

### 3. Summary

As described above, the digital camera 1 of the present embodiment includes the image sensor 110 as an example of an image sensor, the camera controller 140 as an example of a controller, and the user interface 130 as an example of a configurator. The image sensor 110 captures a subject image via an optical system to generate image data. The camera controller 140 controls continuous shooting and autofocus (AF) operations in the image sensor 110 (steps S1 to S3). The user interface 130 receives a user operation to set a continuous shooting mode from a plurality of continuous shooting modes in which the continuous shooting is performed. The plurality of continuous shooting modes includes an H+ continuous shooting mode as an example of a first continuous shooting mode and an H continuous shooting mode as an example of a second continuous shooting mode. The first continuous shooting mode performs the continuous shooting without displaying a live view image. The second continuous shooting mode performs the continuous shooting with the live view image displayed and at slower shooting speed than in the first continuous shooting mode. In a case where the H+ continuous shooting mode is set by the user interface 130, the camera controller 140 determines, on the basis of a state in the digital camera 1, whether the AF operation is performable by the PDAF as an example of a predetermined detection method in the continuous shooting by the H+continuous shooting mode (steps S14, S21, S24, and S42). When the AF operation is performable by the PDAF (step S14: YES, step S21: YES, step S24: YES, step S42: YES), the camera controller 140 performs the continuous shooting by the H+ continuous shooting mode (step S22). When the AF operation is not performable by the PDAF (step S14: NO, step S21: NO, step S24: NO, step $42: NO), the camera controller 140 changes the continuous shooting by the H+ continuous shooting mode and the AF operation by the PDAF, or changes the continuous shooting by the H+ continuous shooting mode (steps S27, S28 to S30, and S43).

According to the digital camera 1 described above, when the PDAF on a still image to be captured is performable in a state where the H+ continuous shooting mode is set, the continuous shooting by the H+ continuous shooting mode is performed, the H+ continuous shooting mode performing the continuous shooting without displaying the live view image, for example. Therefore, relatively high-speed continuous shooting by the H+ continuous shooting mode can be performed with the AF operation by the PDAF being continuously performed, for example. On the other hand, when the PDAF is not performable in the continuous shooting, the continuous shooting and the AF operation are changed, or the continuous shooting is changed. Therefore, by changing the continuous shooting to continuous shooting in which an AF operation other than the PDAF is performable on a still image, for example (steps S27 and S43), it is possible to continuously perform the AF operation in the continuous shooting (steps S28 to S31).

In the present embodiment, when the AF operation is not performable by the PDAF (step S14: NO, step S21: NO, step S24: NO), the camera controller 140 changes the continuous shooting in the H+ continuous shooting mode to the H continuous shooting as an example of the continuous shooting during which the live view image is captured by the image sensor 110 (step S27). Therefore, for example, even when the PDAF is not performable on a still image in the continuous shooting, the AF operation can be performed by using a live view image (steps S28 and S29).

In the present embodiment, the camera controller 140 switches the detection method from the PDAF to, as an example of a detection method for detecting a focusing state on the basis of a live view image, the contrast AF or PDAF each based on a live view image, and then continues the AF operation in the changed continuous shooting such as the H continuous shooting, which is performed after the above change of the continuous shooting (step S29 and S30). Therefore, for example, it is possible to continuously perform the AF operation to track the subject with the continuous shooting being performed.

In the present embodiment, the digital camera 1 further includes the LCD monitor 120 as an example of a display to display an image. When the H continuous shooting mode is set by the user interface 130, as illustrated in FIG. 8A, the camera controller 140 causes the LCD monitor 120 to display a black image as an example of a predetermined image over a blank period in which the live view image is not captured by the image sensor 110, during the continuous shooting by the H continuous shooting mode. When the continuous shooting being performed by the H+ continuous shooting mode is changed (step S27), as illustrated in FIG. 8C, the camera controller 140 causes the LCD monitor 120 to display the live view image captured by the image sensor 110 before the black period, over the blank period during the changed H continuous shooting.

As described above, in the display in the H continuous shooting mode as exemplified in FIG. 8A, the user can see the live view images with the black image interposed between successive live view images in the continuous shooting. This facilitates performing the continuous shooting following the moving subject. On the other hand, in the continuous shooting after the switching to the H continuous shooting, as illustrated in FIG. 8C, instead of the still image in the H+ continuous shooting mode before the switching as illustrated in FIG. 8B, the previous live view image is continuously displayed until the next live view image is obtained. Therefore, for example, a change in appearance before and after the switching can be suppressed, and the user can easily perform continuous shooting.

In the present embodiment, as the predetermined detection method, an AF operation by the image plane phase difference method in the image sensor 110 (PDAF) is performed. Therefore, focusing can be performed at a relatively high speed by calculating a defocus amount, for example. Furthermore, in the H+ continuous shooting mode or the like, the AF operation can be performed on a still image to be captured for recording even when a live view image is not captured.

In the present embodiment, the camera controller 140 determines whether the AF operation is performable by the PDAF, on the basis of at least one of the aperture value in the optical system and the ISO sensitivity of the image sensor 110 (steps S14, S24, and S28). Therefore, it is possible to determine that the PDAF is not performable when it is difficult to obtain a calculation result of the PDAF with high accuracy, such as when the aperture value is relatively small and/or the ISO sensitivity is relatively high.

In the present embodiment, the digital camera 1 further includes the body mount 150 and the lens mount 250 each as an example of a connector to detachably connect the interchangeable lens 200. The camera controller 140 acquires the lens data stored in the interchangeable lens 200 from the interchangeable lens 200 connected via the body mount 150 and the lens mount 250 (step S41), and determines, based on the lens data, whether the AF operation is performable by the PDAF (step S42). Therefore, for example, without depending on either a still image or a live view image is captured by the image sensor 110, it is possible to determine whether the PDAF is performable, based on the interchangeable lens 200 itself mounted on the digital camera 1.

In the present embodiment, after changing the continuous shooting by the H+ continuous shooting mode (step S27), the camera controller 140 continues the changed H continuous shooting (step S3). Therefore, for example, even when the performability of the PDAF changes after the continuous shooting is changed, it is possible to suppress a change in behavior of the imaging operation and the like due to further change of the continuous shooting.

In the present embodiment, the camera controller 140 determines whether the AF operation is performable by the PDAF (steps S42, S11, S14, S24, and S28) when activating the digital camera 1 (e.g., as in FIG. 9), when waiting for continuous shooting such as when performing the shooting standby processing (step S1), and when performing the continuous shooting (step S3). The determination of whether the PDAF is performable does not need to be performed at the times as the above example, but may be performed at least one of at the time of activation of the digital camera 1, at the time of standby before continuous shooting (step S1), and at the time of continuous shooting (step S3). For example, in a case where the determination is performed only at the time of the standby before continuous shooting, when the PDAF is not performable on the still image (step S14: NO) in the shooting standby processing (step S1) exemplified in FIG. 5, the continuous shooting mode can be changed to the H continuous shooting mode similarly to step S43 in FIG. 9 in addition to step S16.

### Second Embodiment

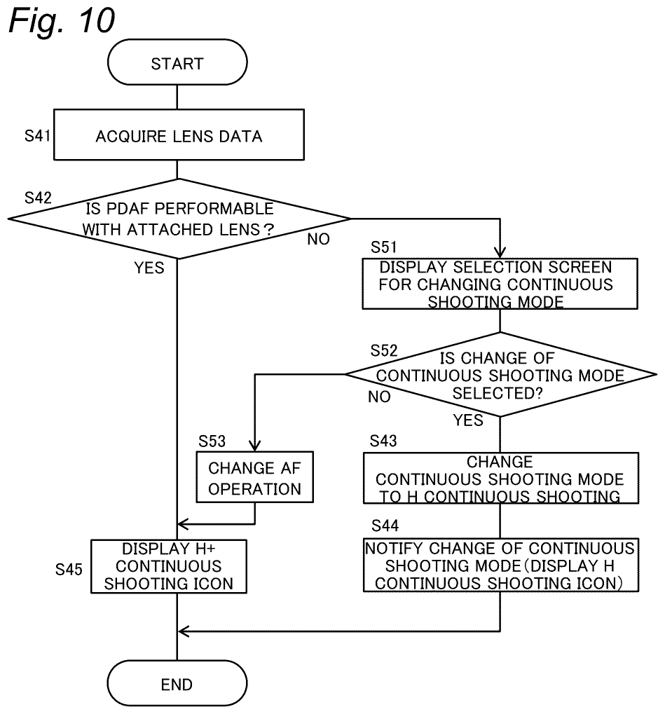

Hereinafter, with reference to FIGS. 10 to 12, a second embodiment of the present disclosure will be described. The first embodiment describes the digital camera 1 changes the continuous shooting mode to the H continuous shooting mode when the PDAF is not performable with the mounted interchangeable lens 200 (step S42: NO) in the state where the H+ continuous shooting mode is set. The second embodiment describes a digital camera in which a user can select whether to change the continuous shooting mode when the PDAF is not performable.

In the following, the digital camera 1 according to the present embodiment will be described. A configuration and an operation similar to those of the digital camera 1 according to the first embodiment will be omitted appropriately.

FIG. 10 is a flowchart for describing an operation of the digital camera 1 according to the second embodiment. In addition to the process (steps S41 to S45 in FIG. 9) similar to that of the digital camera 1 of the first embodiment, the digital camera 1 of the present embodiment performs processes (steps S51 to S53) related to a user selection regarding whether to change the continuous shooting mode.

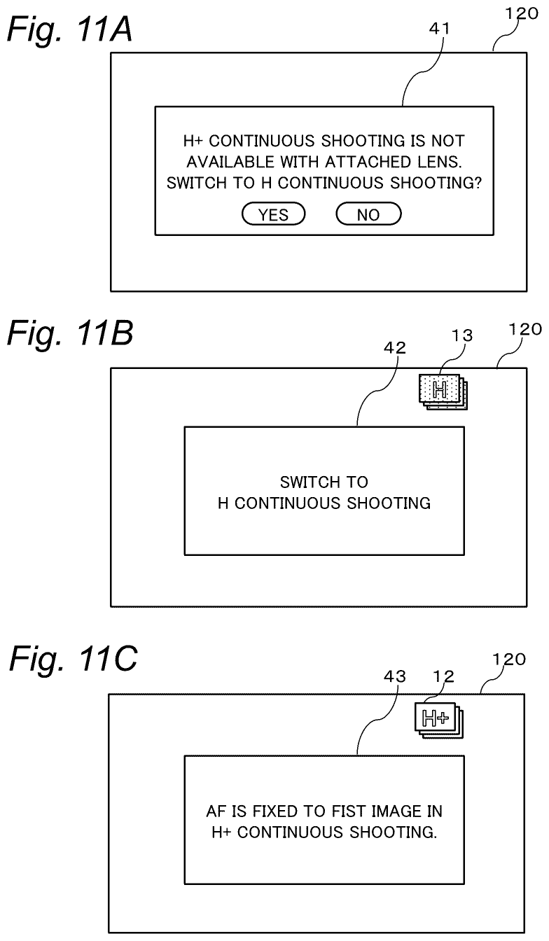

For example, when the PDAF is not performable with the mounted interchangeable lens 200 (step S42: NO), the camera controller 140 causes the LCD monitor 120 to display a selection screen for allowing the user to select whether to change the continuous shooting mode (step S51). A display example of such a selection screen is illustrated in FIG. 11A.

FIGS. 11A to 11C illustrate display examples in the digital camera 1 according to the present embodiment. In step S51, the LCD monitor 120 displays a selection screen 41 as illustrated in FIG. 11A, for example. The selection screen 41 displays options to select whether to change the continuous shooting mode and thereby to switch to the H continuous shooting mode.

The camera controller 140 determines whether the change of the continuous shooting mode is selected, on the basis of whether a user operation selecting the change of the continuous shooting mode is input on the user interface 130 by using the selection screen 41 (step S52).

When the change of the continuous shooting mode is selected (step S52: YES), the camera controller 140 changes the continuous shooting mode to the H continuous shooting mode (step S43). When notifying of the change of the continuous shooting mode (step S44), as illustrated in FIG. 11B, the camera controller 140 may cause the LCD monitor 120 to display, in addition to the H continuous shooting icon 13, a burst change message 42 indicating the change to the H continuous shooting mode, for example.

On the other hand, when the change of the continuous shooting mode is not selected, such as when the user operation not to change the continuous shooting mode is input on the user interface 130 by using the selection screen 41, for example (step S52: NO), the camera controller 140 changes the AF operation in the H+ continuous shooting mode (step S53). For example, the AF operation for tracking the subject is changed to an AF operation in which a focusing state is not changed during the continuous shooting from a focusing state determined at the time of image capturing of the first frame. For example, the focusing state for the first frame of the continuous shooting may be determined by the contrast AF or the like on the basis of the live view image or the like captured immediately before the start of the continuous shooting.

In step S53, as illustrated in FIG. 11C, in addition to the H+ continuous shooting icon 12, the camera controller 140 may cause the LCD monitor 120 to display an AF change message 43 indicating that the focusing state is fixed in the AF operation, for example.

According to the above processing, when the H+ continuous shooting mode is set in the digital camera 1 and the PDAF is not performable with the mounted interchangeable lens 200 (step S42: NO), whether to change the continuous shooting mode can be selected by a user operation (steps S51 and S52). When the continuous shooting mode is not changed (step S52: NO), the AF operation is changed in the H+ continuous shooting mode (step S53). For example, when the PDAF is not performable, the user can select to prioritize the continuous shooting speed in the H+ continuous shooting mode over the continuous AF operation in the continuous shooting. As described above, the AF operation and the continuous shooting can be performed in accordance with the user's preference.

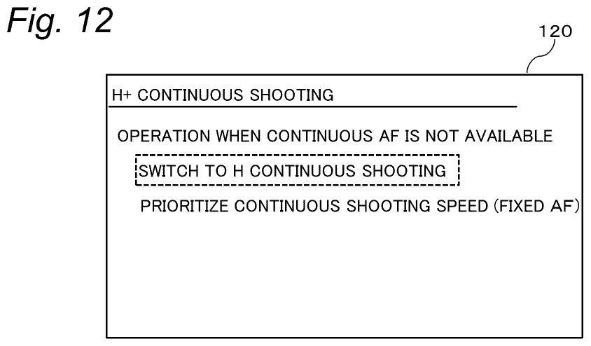

In the above description, an example is described in which, when the PDAF is not performable for the interchangeable lens 200, whether to change the continuous shooting mode is selected by the user operation. Such a selection by the user operation does not need to be performed as in the above example, and when the H+ continuous shooting mode is set, the selection by the user operation may be performed as a setting before continuous shooting, for example. Such a variation will be described with reference to FIG. 12. FIG. 12 illustrates a display example in the digital camera 1 of a variation of the present embodiment.

As illustrated in FIG. 12, on the LCD monitor 120, the digital camera 1 of the present variation displays, as a setting menu or the like, options for a case where the subject cannot be tracked by the PDAF in the H+ continuous shooting mode, for example. For example, the camera controller 140 receives, on the user interface 130, a user operation selecting an option corresponding to each of steps S43 and S53 in FIG. 10 by using a menu screen as illustrated in FIG. 12. In the example of FIG. 12, an option to change the continuous shooting mode corresponding to step S43 is selected.

The digital camera 1 of the present variation can facilitate performing the AF operation and the continuous shooting in accordance with a user's preference, even in a case where the PDAF is not performable due to various factors other than the interchangeable lens 200, such as a change in settings for image shooting and/or a change of the AF area in continuous shooting, for example.

As described above, in the present embodiment, when the AF operation is not performable by the PDAF (step S42: NO), the camera controller 140 changes the AF operation (step S53). Therefore, the subject can be tracked by the performable AF operation with the continuous shooting by the H+ continuous shooting mode being performed, for example. With the above embodiments, when the AF operation is not performable by the PDAF (step S14: NO, step S21: NO, step S24: NO, step S42: NO), the camera controller 140 changes at least one of the continuous shooting by the H+ continuous shooting mode and the AF operation by the PDAF (steps S27, S28 to S30, S43, and S53).

In the present embodiment, the digital camera 1 further includes the user interface 130 that receives a user operation. The camera controller 140 receives, via the user interface 130, a user operation selecting an option for choosing whether to switch to the H continuous shooting, as an example of a first option or a second option each being an option of operation in a case where the AF operation is not performable by the PDAF in the continuous shooting by the H+ continuous shooting mode (steps S51 to S52, see FIG. 11A). In the case where the AF operation is not performable by the PDAF (step S42: NO), when the option of switching to the H continuous shooting is selected (step S52: YES), the camera controller 140 changes the continuous shooting in the H+ continuous shooting mode to the H continuous shooting in which the live view image is captured by the image sensor 110 (step S43). When the option of not switching to the H continuous shooting is selected (step S52: NO), the camera controller 140 does not change a focusing state determined by the AF operation at a start of the continuous shooting, during the continuous shooting by the H+ continuous shooting mode (see step S53 and FIG. 11C).

According to the digital camera 1 described above, for example, when the PDAF is not performable in the continuous shooting by the H+ continuous shooting mode, the user can select one of: continuing the continuous shooting by the H+ continuous shooting mode with the focusing state in the AF operation being fixed since a start of the shooting; and the switching the continuous shooting by the H+ continuous shooting mode to the H continuous shooting to continue the AF operation. This also enables the continuous shooting and the AF operation to be performed in accordance with the user's preference.

### Other Embodiments

The first and second embodiments are described in the above as examples of the techniques disclosed in the present application. However, the techniques of the present disclosure can be applied not only to the above embodiments but also to an embodiment in which modification, replacement, addition, or removal is appropriately made. Furthermore, it is possible to form a new embodiment by combining the components described in the above first and second embodiments.

In each of the above embodiments, an example is described in which, in the PDAF, a defocus amount or the like in accordance with the difference between two types of optical images generated by pupil division is calculated on the basis of the sensor signals from the sensor pixels 111 of the image sensor 110. In the present embodiment, the sensor pixels may be pupil-divided to form four types of optical images in up-and-down and right-and-left directions, for example.

In each of the above embodiments, an example is described in which the image sensor 110 includes the sensor pixels 111 disposed instead of the pixels for image capturing. In the present embodiment, in the image sensor, the pixels for image capturing may further have a function as a distance measuring sensor. For example, all the pixels of the image sensor may have both functions of image capturing and distance measurement.

In each of the above embodiments, it is described that the AF operation by the PDAF is performed on the basis of the sensor signals from the sensor pixels 111 of the image sensor 110. In the present embodiment, the digital camera may include, instead of or in addition to the sensor pixels 111, a phase difference sensor separately from the image sensor 110, and the AF operation may be performed on the basis of a sensor signal from the phase difference sensor.

In each of the above embodiments, an example is described in which the digital camera 1 displays an image captured by the image sensor 110 on the LCD monitor 120. In the present embodiment, the digital camera may be connected to various displays such as external LCD monitors via a connection circuit such as HDMI in the communication module 155, and the image may be displayed on an external display under control of the camera controller 140. In the present embodiment, the communication module 155 connected to such an external display may constitute the display of the digital camera, and the digital camera may not include the LCD monitor 120.

In the first embodiment described above, an example is described in which, after the continuous shooting is changed in the continuous shooting by the H+ continuous shooting mode, the H continuous shooting after the change is continued (step S3 and S27 to S31). In the present embodiment, for example, when the PDAF becomes performable due to a change in the state in the digital camera 1 and the like after the continuous shooting is changed, the H+ continuous shooting before the change may be performed again.

In each of the above embodiments, as a method of detecting the focusing state on the basis of a live view image, control by the contrast AF is performed (steps S13 and S30). The contrast AF may be performed not only based on a live view image but also based on various images captured separately from the still image for recording, for example.

In each of the above embodiments, the digital camera 1 performs control by the PDAF as a predetermined detection method in the AF operation (steps S12, S23, and S29), and switches to the contrast AF when the PDAF is not performable (steps S11, S13, S14, S21, S24, and S30). The present disclosure does not need to be applied to the PDAF and the contrast AF but may be applied to, among control methods of the AF operation using various distance measuring methods or distance information, control methods that have a relationship similar to the relationship between the PDAF and the contrast AF. Examples of such various control methods include, but are not limited to: a depth from defocus (DFD) method using distance measurement by a DFD technique; a time of flight (TOF) method in which a distance measurement instrument is disposed inside or outside the digital camera; a range finder; and a distance measuring method using distance measurement by various types of active sensing.

Each of the above embodiments exemplifies the digital camera 1 including the interchangeable lens 200. The imaging apparatus of the present embodiment may be a built-in lens camera capable of the AF operation.

Each of the above embodiments describes the digital camera as the imaging apparatus, but the imaging apparatus is not limited to the digital camera. The imaging apparatus of the present disclosure may be electronic equipment having an image capturing function in a plurality of operation modes. The electronic equipment includes, for example, a video camera, a smartphone, and a tablet terminal.

As described above, the embodiments are described as the exemplification of the technique in the present disclosure. To that end, the accompanying drawings and the detailed description are provided.

Therefore, among the components described in the accompanying drawings and the detailed description, not only the component essential for solving the problem, but also the component not essential for solving the problem may be included in order to exemplify the above technique. Therefore, it should not be recognized that these non-essential components are essential immediately because these non-essential components are described in the accompanying drawings and the detailed description.

In addition, since the above embodiments are for illustrating the technique in the present disclosure, various changes, substitutions, additions, omissions, and the like can be made within the scope of the claims or the equivalent thereof.

### Aspect Examples

### Hereinafter, Various Aspects of the Present Disclosure Will be Exemplified

A first aspect according to the present disclosure is an imaging apparatus includes: an image sensor that captures a subject image via an optical system to generate image data; a controller that controls continuous shooting and an autofocus operation in the image sensor; and a configurator that sets a continuous shooting mode from a plurality of continuous shooting modes to cause the image sensor to perform continuous shooting. The plurality of continuous shooting modes includes a first continuous shooting mode and a second continuous shooting mode, the first continuous shooting mode performing the continuous shooting without displaying a live view image, the second continuous shooting mode performing the continuous shooting with the live view image displayed and at slower shooting speed than in the first continuous shooting mode. In a case where the first continuous shooting mode is set by the configurator, the controller determines, based on a state in the imaging apparatus, whether the autofocus operation is performable by a predetermined detection method in the continuous shooting by the first continuous shooting mode. When the autofocus operation by the predetermined detection method is performable, the controller performs the continuous shooting in the first continuous shooting mode. When the autofocus operation by the predetermined detection method is not performable, the controller changes at least one of the continuous shooting by the first continuous shooting mode and the autofocus operation.

A second aspect is the imaging apparatus according to the first aspect, wherein when the autofocus operation is not performable by the predetermined detection method, the controller changes the continuous shooting in the first continuous shooting mode to the continuous shooting during which the live view image is captured by the image sensor.

A third aspect is the imaging apparatus according to the second aspect, wherein the controller switches from the predetermined detection method to a detection method in which a focusing state is detected based on the live view image, and continues the autofocus operation in the changed continuous shooting.

A fourth aspect is the imaging apparatus according to the second or third aspect, further including a display that displays an image, wherein when the second continuous shooting mode is set by the configurator, the controller causes the display to display a predetermined image over a blank period in which the live view image is not captured by the image sensor, during the continuous shooting by the second continuous shooting mode, and when the continuous shooting being performed by the first continuous shooting mode is changed, the controller causes the display to display the live view image captured before the blank period, over the blank period during the changed continuous shooting.

A fifth aspect is the imaging apparatus according to any of the first to fourth aspects, wherein the predetermined detection method is an image plane phase difference method in the image sensor.

A sixth aspect is the imaging apparatus according to any of the first to fifths aspects, wherein the controller determines whether the autofocus operation is performable by the predetermined detection method, based on at least one of an aperture value in the optical system or ISO sensitivity in the image sensor.

A seventh aspect is the imaging apparatus according to any of the first to sixth aspects, further comprising a connector that detachably connects an interchangeable lens, wherein the controller acquires lens data from the interchangeable lens connected via the connector, the lens data being stored in the interchangeable lens; and the controller determines, based on the lens data, whether the autofocus operation is performable by the predetermined detection method.

A eighth aspect is the imaging apparatus according to any of the first to seventh aspects, wherein after changing the continuous shooting being performed by the first continuous shooting mode, the controller continues the changed continuous shooting.

A ninth aspect is the imaging apparatus according to any of the first to eighth aspects, further comprising a user interface that receives a user operation, wherein the controller receives a user operation selecting a first option or a second option via the user interface, the first option and the second option each being an option of operation in a case where the autofocus operation is not performable by the predetermined detection method in the continuous shooting by the first continuous shooting mode. In the case where the autofocus operation is not performable by the predetermined detection method, when the first option is selected, the controller changes the continuous shooting in the first continuous shooting mode to the continuous shooting in which the live view image is captured by the image sensor, and when the second option is selected, the controller maintains a focusing state determined by the autofocus operation at a start of the continuous shooting, during the continuous shooting by the first continuous shooting mode.

A tenth aspect is the imaging apparatus according to any of the first to ninth aspects, wherein the controller determines whether the autofocus operation is performable by the predetermined detection method at least one of when activating the imaging apparatus, when waiting for the continuous shooting, or when performing the continuous shooting.

The present disclosure can be applied to various types of an imaging apparatus that performs continuous shooting and an autofocus operation.

1. An imaging apparatus comprising:
an image sensor that captures a subject image via an optical system to generate image data;
a controller that controls continuous shooting and an autofocus operation in the image sensor; and
a configurator that sets a continuous shooting mode from a plurality of continuous shooting modes to cause the image sensor to perform continuous shooting, wherein
the plurality of continuous shooting modes includes a first continuous shooting mode and a second continuous shooting mode, the first continuous shooting mode performing the continuous shooting without displaying a live view image, the second continuous shooting mode performing the continuous shooting with the live view image displayed and at slower shooting speed than in the first continuous shooting mode, and
in a case where the first continuous shooting mode is set by the configurator,
the controller determines, based on a state in the imaging apparatus, whether the autofocus operation is performable by a predetermined detection method in the continuous shooting by the first continuous shooting mode, and
when the autofocus operation by the predetermined detection method is performable, the controller performs the continuous shooting by the first continuous shooting mode, and
when the autofocus operation by the predetermined detection method is not performable, the controller changes at least one of the continuous shooting in the first continuous shooting mode or the autofocus operation.

2. The imaging apparatus according to claim 1, wherein
when the autofocus operation is not performable by the predetermined detection method, the controller changes the continuous shooting in the first continuous shooting mode to the continuous shooting during which the live view image is captured by the image sensor.

3. The imaging apparatus according to claim 2, wherein
the controller switches from the predetermined detection method to a detection method in which a focusing state is detected based on the live view image, and continues the autofocus operation in the changed continuous shooting.

4. The imaging apparatus according to claim 2, further comprising
a display that displays an image, wherein
when the second continuous shooting mode is set by the configurator, the controller causes the display to display a predetermined image over a blank period in which the live view image is not captured by the image sensor, during the continuous shooting by the second continuous shooting mode, and
when the continuous shooting being performed by the first continuous shooting mode is changed, the controller causes the display to display the live view image captured before the blank period, over the blank period during the changed continuous shooting.

5. The imaging apparatus according to claim 1, wherein
the predetermined detection method is an image plane phase difference method in the image sensor.

6. The imaging apparatus according to claim 1, wherein
the controller determines whether the autofocus operation is performable by the predetermined detection method, based on at least one of an aperture value in the optical system or ISO sensitivity in the image sensor.

7. The imaging apparatus according to claim 1, further comprising
a connector that detachably connects an interchangeable lens, wherein
the controller acquires lens data from the interchangeable lens connected via the connector, the lens data being stored in the interchangeable lens; and
the controller determines, based on the lens data, whether the autofocus operation is performable by the predetermined detection method.

8. The imaging apparatus according to claim 1, wherein
after changing the continuous shooting being performed by the first continuous shooting mode, the controller continues the changed continuous shooting.

9. The imaging apparatus according to claim 1, further comprising
a user interface that receives a user operation, wherein
the controller receives a user operation selecting a first option or a second option via the user interface, the first option and the second option each being an option of operation in a case where the autofocus operation is not performable by the predetermined detection method in the continuous shooting by the first continuous shooting mode; and
in the case where the autofocus operation is not performable by the predetermined detection method,
when the first option is selected, the controller changes the continuous shooting in the first continuous shooting mode to the continuous shooting in which the live view image is captured by the image sensor, and
when the second option is selected, the controller maintains a focusing state determined by the autofocus operation at a start of the continuous shooting, during the continuous shooting by the first continuous shooting mode.

10. The imaging apparatus according to claim 1, wherein
the controller determines whether the autofocus operation is performable by the predetermined detection method at least one of when activating the imaging apparatus, when waiting for the continuous shooting, or when performing the continuous shooting.
